(19) United States
(12) Patent Application Publication
(10) Pub. No.: US 2015/0341374 A1
(43) Pub. Date: Nov. 26, 2015

(54) UNIFIED INTERFACE FOR ANALYSIS OF AND RESPONSE TO SUSPICIOUS ACTIVITY ON A TELECOMMUNICATIONS NETWORK

(71) Applicant: Vahna, Inc., Alexandria, VA (US)

(72) Inventors: Brendan Conlon, Alexandria, VA (US); LaTonya Hall, Macon, GA (US)

(21) Appl. No.: 14/811,998

(22) Filed: Jul. 29, 2015

Related U.S. Application Data
(63) Continuation-in-part of application No. 14/105,898, filed on Dec. 13, 2013, now abandoned.

(51) Int. Cl. H04L 29/06; H04Q 9/00

(52) U.S. Cl. CPC H04L 63/145; H04Q 9/00; H04L 63/1408

(57) ABSTRACT

The invention is a platform for analysis of disparate data sources and automated and or user driven incident response via a single user interface. The platform includes an agent server, message broker, index, correlation engine and user interface. Telemetry sources may include network appliances, mobile devices, and standard terminals. Each telemetry type has interactions that enable incident response from the unified interface.

### CROSS-REFERENCE TO EARLIER APPLICATION

This application is a Continuation in Part of application Ser. No. 14/105,898 filed Dec. 13, 2013. The entire content of this application is incorporated herein by reference.

### FIELD OF THE INVENTION

The present invention relates to telecommunications networks and the security of such networks. More particularly, the present invention relates to a user interface providing the ability to analyze data from disparate sources and respond to incidents of malicious activity with defensive actions.

### BACKGROUND OF THE INVENTION

Though the Internet was designed to allow for the freest possible exchange of information, the nature of a distributed network makes it vulnerable to exploitation. Unauthorized dumps of databases with personally identifiable information and intellectual property theft have become prevalent.

To detect or prevent such attacks, Intrusion Detection/Prevention Systems (IDS/IPS) that alert and alter security configuration based on known attack signatures have been developed. The status quo IDS/IPS is typically comprised of hardware that is dedicated to intrusion detection via the analysis of raw network data or an endpoint application that analyzes host data. As each appliance or application has its own interface, Security Information and Event Management (SIEM) systems were developed such that aggregate alert and log data could be reviewed from one interface. However, even with the implementation of STEM technology, responders are still typically required to use a separate application and its associated user interface to take an action that thwarts the threat. The gap in the ability to simply and efficiently fuse and distill network and host/endpoint telemetry into a unified interface for the analysis of and response to suspicious activity remains.

Accordingly, there is a need for a system that provides one interface for analysis of disparate data sources and on demand defensive response actions.

U.S. Pat. No. 8,141,157 to Farley et al. discloses a method and system which manages computer security information in which multiple data sources such as sensors or detectors used in intrusion detection systems monitor data traffic. The information from the sensors is fused in a fusion engine to identify relationships between real time computer events and assess and rank the risk of real-time raw events and mature correlation events.

U.S. Pat. No. 7,712,133 to Raiker et al. discloses an integrated intrusion detection method in which information from a plurality of intrusion detector sensors is gathered and processed to provide a consolidated correlation of information. A severity is assigned to the information based on an enterprise wide security policy and a response is assigned and implemented in accordance with the severity.

U.S. Pat. No. 7,313,695 to Norton et al. discloses a system for dynamically assessing threats to computers and computer networks. Events from a plurality of security devices are analyzed to determine what combination of attacks coming from and going to various hosts would indicate that a larger coordinated attack is in progress. The security devices include network intrusion detection systems, host intrusion detection systems, routers, firewalls, and system loggers.

While the prior systems provide some useful functionality, the singular functionality of each has made incident response times stagnate. As prevention has been proven a highly touted myth, dual analysis and response platforms will become a requirement for security operations centers.

### SUMMARY OF THE INVENTION

It is the primary objective of the invention to provide a platform with a single interface for conducting malware hunt operations and the corresponding incident response on an enterprise network.

### BRIEF DESCRIPTION OF THE FIGURES

Other objects and advantages of the invention will become apparent from a study of the following specification when viewed in the light of the accompanying drawing, in which:

FIG. 1 is a network diagram showing the system in accordance with an embodiment of the present invention; and

FIG. 2 is a flow chart showing a defensive response action on a customer network from the user interface.

### DETAILED DESCRIPTION

Although the illustrative embodiment will be generally described in the context of program modules running on a personal computer and server, those skilled in the art will recognize that the present invention may be implemented in conjunction with operating system programs or with other types of program modules for other types of computers. Furthermore, those skilled in the art will recognize that the present invention may be implemented in either a stand-alone device or in a distributed computing environment or both.

As described herein, a process is generally considered to be a sequence of computer-executed steps leading to a desired result. Moreover, the programs, processes, methods, etc. described herein are not related or limited to any particular computer or apparatus. Rather, various types of general-purpose machines may be used with the program modules constructed in accordance with the teachings described herein. Similarly, it may prove advantageous to construct a specialized apparatus to perform the method steps described herein by way of dedicated computer systems in specific network architecture.

The present invention includes a set of integrated technologies that enable near real-time and historical analysis of logs, host and network telemetry to highlight suspicious activity. Logs, telemetry, analytic results, and response actions are available from a unified interface.

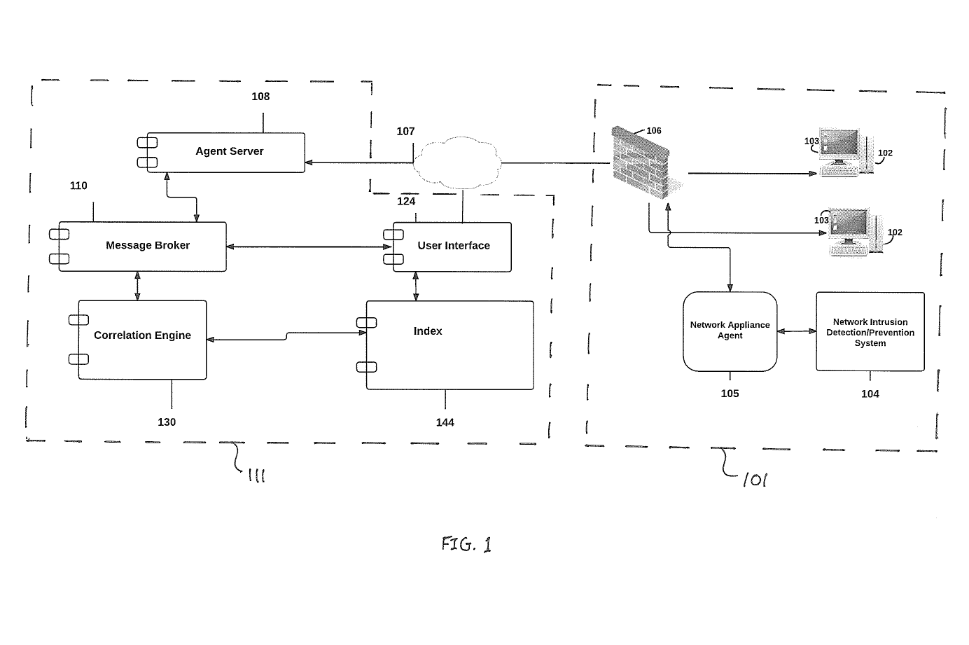

FIG. 1 shows a diagram of a system in accordance with the present invention. The system includes various components. A customer network 101 incorporates various devices or modules that are connected via a network. These modules may be physically located at a single facility or may be located in geographically diverse locations. The customer network may include machines, terminals or hosts 102. These hosts are appliances or devices connected to the customer network 101 and may be any type of network appliance or terminal as would be known to one of ordinary skill in the art, including, but not limited to desktop personal computers, laptops, handheld devices, tablets, smartphones, servers, or the like.

The hosts 102 include agent software 103. The agent software includes telemetry gathering and response action tasking functionality along with other software utilities.

The customer network 101 includes a Network Intrusion Detection/Prevention System (NIDS/NIPS) 104. The NIDS/NIPS includes a purpose built networked appliance or a general-purpose personal computer or server programmed with software containing specific instructions. By way of example, the NIDS may comprise Sourcefire, Inc.'s Snort®. The NIDS 104 may include a system log that stores network traffic statistics and or raw data on the device executing the NIDS software. The NIDS 104 further preferably includes a database for storage of this information as well as a user interface and other functions.

A network appliance agent 105 is connected with the Network Intrusion Detection/Prevention System 104. The network appliance agent software provides telemetry forwarding and response action tasking functionality along with other software utilities. Specifically, the network appliance agent integrates with the NIDS and other network appliances to implement defensive response actions.

The customer network 101 may include additional hosts, computers, servers and other devices that are not shown and may be made up of one or more local area networks (LAN) or wide area networks (WAN). The customer network is preferably connected to the Internet 107. A firewall 106 may be used to control incoming and outgoing network traffic between the customer network 101 and the Internet 107 or some other WAN.

A system in accordance with the present invention also includes a provider network 111. The provider network includes a variety of machines or terminals. These machines may be physically co-located or may be located in geographically diverse locations and connected by a LAN, WAN or the Internet. The connections illustrated in FIG. 1 are illustrative only, and it should be understood that any appropriate network or arrangement of connections could be used as would be understood by one of ordinary skill in the art.

The provider network includes an agent server 108. The agent server 108 manages command and control for agents 103 and 105 of the customer network 101.

The provider network 111 also includes a correlation engine 130 that fuses and correlates Network Appliance (NA) alerts/logs/telemetry and Host Agent (HA) instrumentation data to detect suspicious activity.

A message broker 110 is connected between the agent server 108 and the correlation engine 130. The message broker facilitates on demand correlation engine 130 to agents 103 and 105 and user interface 124 to agents 103 and 105 communications.

The provider network 111 includes an index 144 such as a search server or database that indexes and houses telemetry/logs/alerts. By way of example, the index may include ElasticSearch software.

Lastly, the provider network 111 includes a user interface 124 connected with the message broker 110, the index 144 and the Internet that allows the analysis of host and network logs, telemetry, analytic results, and the issuance of response actions on the customer network 101 via the agent server 108 and message broker 111.

For example, the process telemetry type may have the following interactions available via the unified user interface:
1. Kill process
2. Download module
3. Checksum module
4. Delete module
5. Dump memory
6. Show all data received within a two minute window
   Network appliance telemetry/logs/alerts may have the following interactions available via the unified user interface:
1. Drop connection
2. Block future connections
3. Dump raw packets
4. Show all data received within a two minute window

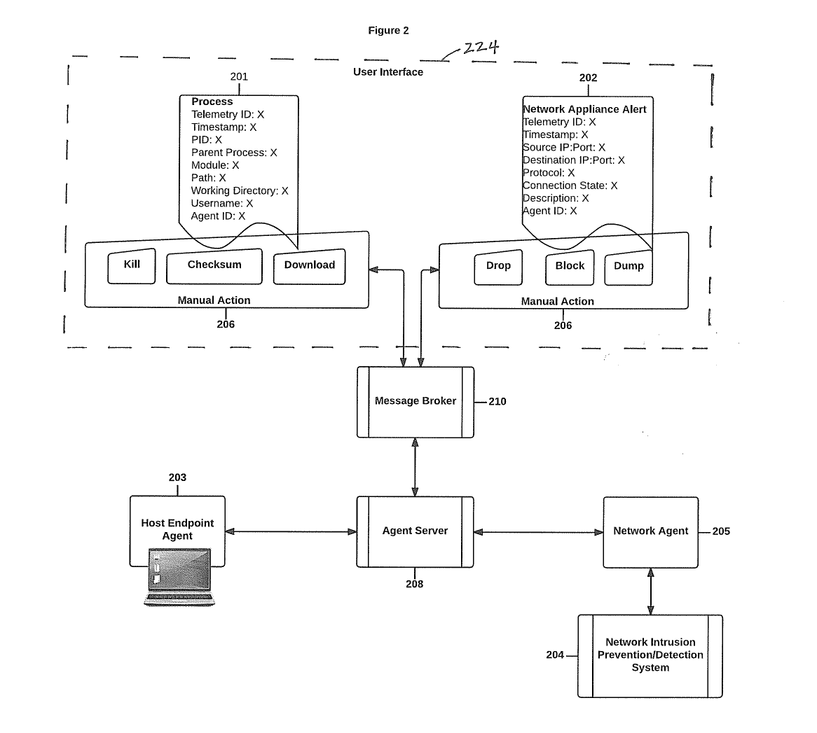

FIG. 2 illustrates the workflow from user interface action invocation to customer network response. For illustration, a user hunting malware monitors telemetry type at step 201. The user then decides that further information is required or some immediate response is warranted at step 206. This triggers the generation of a message to the message broker 210. Each agent has a unique agent ID and associated queue on the message broker 210. The agent server 208 consumes all agent queues and issues the appropriate command to the correct host agent 203. A message of success that includes any resultant data is delivered back to the agent server 208. The user interface 224 consumes the per action 206 exclusive queue to capture and distill results. Those skilled in the art will recognize that there is a parallel process for the network appliance alert telemetry type 202.

While the preferred forms and embodiments of the invention have been illustrated and described, it will be apparent to those of ordinary skill in the art that various changes and modifications may be made without deviating from the inventive concepts set forth above.

What is claimed is:

1. A system for analyzing telemetry in customer and provider networks, comprising
(a) a network intrusion detection device which detects potentially malicious traffic directed toward the telemetry; and
(b) a network appliance device connected with said network intrusion detection device for implementing defensive response actions in response to detection of potentially malicious traffic.

2. A system as defined in claim 1, and further comprising at least one agent at a host and network component of the telemetry for collecting telemetry and issuing defensive response actions.

3. A system as defined in claim 2, and further comprising an agent server connected with the provider network for managing communications with host and network agents,

4. A system as defined in claim 3, and further comprising a correlation engine in the provider network to fuse and correlate host and network telemetry, generate alerts, and automate actions in response to potentially malicious traffic.

5. A system as defined in claim 4, and further comprising a message broker connected between said correlation engine and said agent server to facilitate communication between the correlation engine and the agents.

6. A system as defined in claim 5, and further comprising an index connected with said correlation engine for storing information relating to potentially malicious traffic alerts and responses said alerts.

7. A method for analyzing telemetry in customer and provider networks, comprising the steps of
(a) detecting potentially malicious traffic directed toward the telemetry; and
(b) implementing defensive response actions in response to detection of potentially malicious traffic.

8. A method as defined in claim 7, and further comprising the steps of correlating host and network telemetry, generating alerts, and automating actions in response to potentially malicious traffic.

9. A method as defined in claim 8, wherein said correlation step uses an anomaly detection algorithm derived from supervised and unsupervised machine learning techniques to trigger alerts.

10. A method as defined in claim 8, wherein said correlation step uses primary, secondary, and tertiary data points in the telemetry to make an alert decision.

11. A method as defined in claim 9, wherein said correlation step uses threat intelligence feed data to make an alert decision.

12. A method as defined in claim 8, and further comprising the step of storing information relating to potentially malicious traffic alerts and responses said alerts.
